(19) United States
(12) Patent Application Publication
(10) Pub. No.: US 2005/0284249 A1
(43) Pub. Date: Dec. 29, 2005

(54) Worm type gear mover assembly

(76) Inventor: David F. Arnone, Mountain View, CA (US)

Correspondence Address: THE LAW OFFICE OF STEVEN G ROEDER, 5560 CHELSEA AVE, LA JOLLA, CA, 92037, US

(21) Appl. No.: 10/881,947

(22) Filed: Jun. 29, 2004

(51) Int. Cl. G05G 11/00

(52) U.S. Cl. 74/490.07

(57) ABSTRACT

A mover assembly (16) that moves or positions an object (12) includes a mover output (32), a gear (238), and an assembly output (28) that is coupled to the object (12). The mover output (32) is rotated. The gear (238) engages the mover output (32) so that rotation of the mover output (32) results in rotation of the gear (238). The assembly output (28) is coupled to the gear (238) so that rotation of the gear (238) results in movement of the assembly output (28) along an axis (28A). The mover assembly (16) can include a rotation inhibitor (30) that inhibits rotation of the assembly output (28) and allows for movement of the assembly output (28) along the axis (28A). The mover output (32) can include a worm (236) that engages the gear (238) so that rotation of the worm (236) about a worm axis (236A) results in rotation of the gear (238) about a gear axis (238A) that is different than the worm axis (236A).

### BACKGROUND

Micromotors are used to make fine adjustments to the position and/or shape of an object. One type of micromotor assembly includes a motorized micrometer having a gear head that turns a screw or nut. Unfortunately, with certain designs, prior art micromotors are relatively large, do not have a long operational life and/or have a relatively large movement step size.

### SUMMARY

The present invention is directed to a mover assembly that moves or positions an object. In one embodiment, the mover assembly includes a mover output, a gear, and an assembly output that is coupled to the object. The mover output is moved. The gear engages the mover output so that movement of the mover output results in rotation of the gear. The assembly output is coupled to the gear so that rotation of the gear results in movement of the assembly output along an axis.

In one embodiment, the mover assembly includes a rotation inhibitor that inhibits rotation of the assembly output and allows for movement of the assembly output along the axis.

The mover output can include a worm that engages the gear so that rotation of the worm about a worm axis results in rotation of the gear about a gear axis that is different than the worm axis. Further, a gear bearing assembly can allow for rotation of the gear about the gear axis. In this embodiment, the assembly output can be coupled to the gear so that rotation of the gear results in movement of the assembly output along an output axis that is coaxial with the gear axis.

In one embodiment, the gear includes a gear aperture and the assembly output is positioned within the gear aperture. In this embodiment, the gear can include a gear internally threaded surface and the assembly output can include an output externally threaded surface that engages the gear internally threaded surface.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified, perspective illustration of an apparatus that utilizes a mover assembly having features of the present invention;

FIG. 2A is a simplified, plan view of a portion of the mover assembly of FIG. 1;

FIG. 2B is a perspective view of a portion of the mover assembly of FIG. 2A;

FIG. 2C is a cut-away view taken on line 2C-2C of FIG. 2A;

FIG. 3 is a simplified, perspective view of another embodiment of an apparatus having features of the present invention;

FIGS. 4A and 4B are alternative perspective views of yet another embodiment of a mover assembly having features of the present invention;

FIGS. 4C and 4D are alternative cross-sectional views of the mover assembly of FIGS. 4A and 4B;

FIG. 4E is a perspective view of another embodiment of a rotation inhibitor; and

FIG. 4F is an exploded perspective view of the rotation inhibitor of FIG. 4E.

### DESCRIPTION

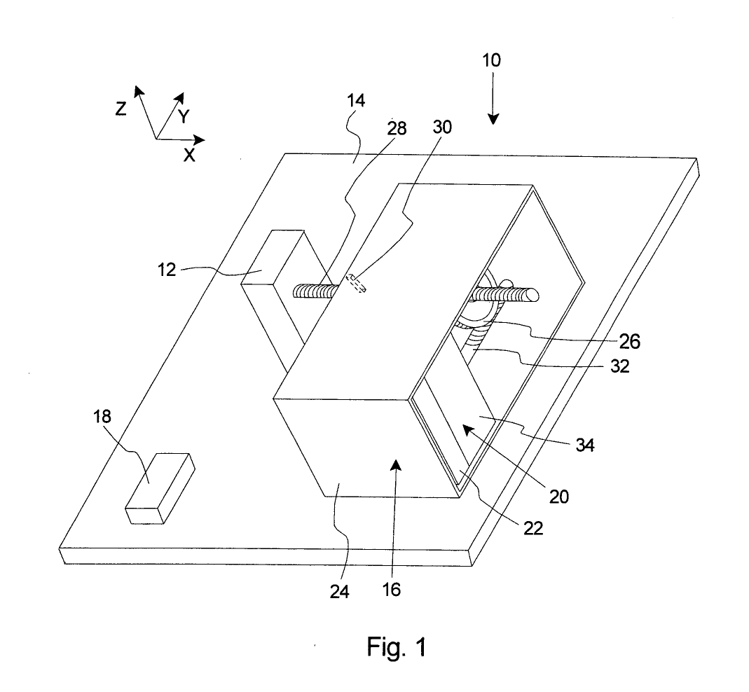

FIG. 1 illustrates a precision apparatus 10 having features of the present invention, that makes fine adjustments to the position and/or shape of an object 12. In one embodiment, the precision apparatus 10 includes an apparatus frame 14, a mover assembly 16 and a control system 18 that directs current to the mover assembly 16 and controls the operation of the apparatus 10. A number of Figures include an orientation system that illustrates an X axis, a Y axis that is orthogonal to the X axis, and a Z axis that is orthogonal to the X and Y axes. It should be noted that these axes can also be referred to as the first, second, and third axes. In general, there are six degrees of freedom, including translation along the X, Y and Z axes and rotation about the X, Y and Z axes.

The design of the components of the apparatus 10 and the type of apparatus 10 can be varied. For example, the apparatus 10 can be used in manufacturing, technical or scientific instruments including lasers, interferometers, mirrors, lenses, telescopes, filters, emitters or detectors. Stated somewhat differently, the mover assembly 16 can be used in connection with manufacturing, technical or scientific instruments including lasers, interferometers, mirrors, lenses, and telescopes. As examples, the object 12 can be a portion or all of a laser, interferometer, mirror, lens, telescope, filters, emitters or detectors.

The apparatus frame 14 is rigid and supports the other components of the apparatus 10.

The mover assembly 16 is coupled to the object 12. The mover assembly 16 has a relatively low mass, small package size, high load capability, wide operating temperature range, long operational life, and/or low power consumption. In one embodiment, the mover assembly 16 has a package size of approximately 25 mm, can provide adjustment with a relatively small step size, e.g approximately 50 nanometers, and has a travel of approximately 0.5 inches. In alternative embodiments, the mover assembly can have a larger or smaller package size, a step size of greater or less than 50 nanometers and/or the range of travel can be greater or less than 0.5 inches.

In one embodiment, as illustrated in FIG. 1, the mover assembly 16 includes a mover 20, a measurement system 22, an assembly frame 24, a gear assembly 26, an assembly output 28, and a rotation inhibitor 30 (illustrated in phantom). The design and orientation of these components can be changed to suit the requirements of the mover assembly 16. Further, one or more of these components can be optional. For example, in one embodiment, the mover assembly 16 does not include the measurement system 22.

The design of the mover 20 can be varied to suit the design requirements of the mover assembly 16. In one embodiment, the mover 20 includes a mover output 32 that moves, e.g. rotates without moving laterally. Alternatively, for example, the mover assembly 16 could be designed so that the mover output 32 rotates and moves axially. Still alternatively, the mover assembly 16 could be designed so that the mover output 32 moves axially without rotating.

In the embodiment illustrated in FIG. 1, the mover 20 also includes a motor 34 that rotates the mover output 32. In one embodiment, for example, the motor 34 is a rotary type motor. Suitable rotary type motors are sold by Maxon, located in Burlingame, Calif. Alternatively, the motor 34 can be a stepper motor. A suitable stepper motor is sold by Parker Hannifin, located in Irwin, Pa. Moreover, other types of motorized micrometers can be used. Other motors 34 can be purchased from ThermoOriel, located in Strafford, Conn. or Newport Corporation, located in Irvine, Calif. Still alternatively, for example, the motor 34 can be another type of actuator such as those sold under the trade name “New Focus Picomotor” available from New Focus, Inc., San Jose, Calif. Still other suitable actuators include magnetostrictive actuators such as those available from Energen and piezoactuators. In one embodiment, the motor 34 generates approximately lNmm of torque on the mover output 32. With this embodiment, the mover assembly 16 generates approximately 10 lbf axial force on the object 12.

In one embodiment, the measurement system 22 provides positional feedback for closed-loop control of the mover assembly 16. The design of the measurement system 22 can be varied. For example, the measurement system 22 can include one or more sensors that monitor the position of a portion of the mover assembly 16 and provide the information to the control system 18. For example, the measurement system 22 can be an encoder, e.g. a rotary encoder that monitors rotation of the mover output 32. Additionally or alternatively, the measurement system 22 can include one or more sensors (not shown) that also monitor the position or shape of the object 12 and provide the information to the control system 18. Components for a suitable measurement system 22 can be obtained from Heidenhain, located in Germany, or from MicroE Systems, located in Natick, Mass.

Still alternatively, the mover assembly 16 can be designed without the measurement system 22. With this design, the mover assembly 16 operates open loop.

The assembly frame 24 retains and/or encircles one or more of the components of the mover assembly 16. In FIG. 1, the assembly frame 24 is rigid, and generally rectangular frame shaped. The assembly frame 24 is fixedly secured to the apparatus frame 14.

The control system 18 receives information regarding the position of the object 12 or a portion of the mover assembly 16. In one embodiment, the control system 18 directs a drive signal to the motor 34 to make fine adjustments to the position and/or shape of the object 12. The control system 18 can include one or more processors and storage systems. In FIG. 1, the control system 18 is positioned away from the mover assembly 16. Alternatively, the control system 18 can be incorporated into the mover assembly 16.

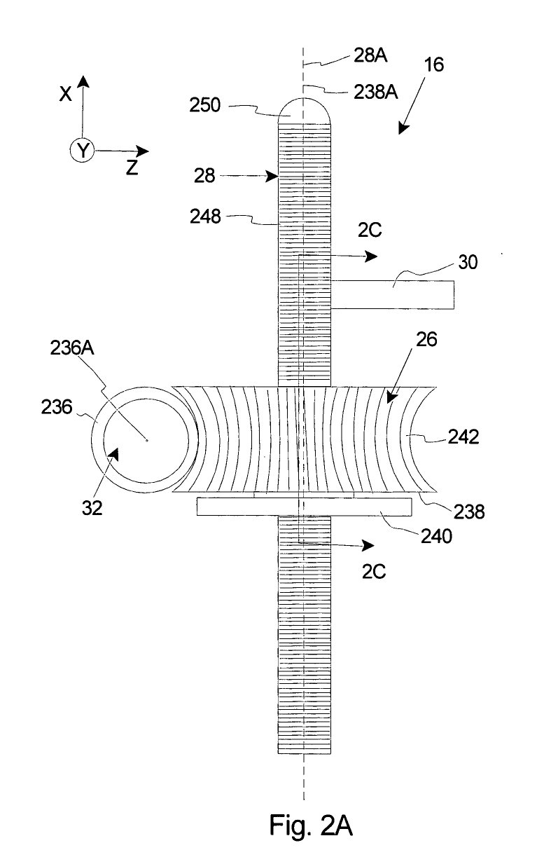

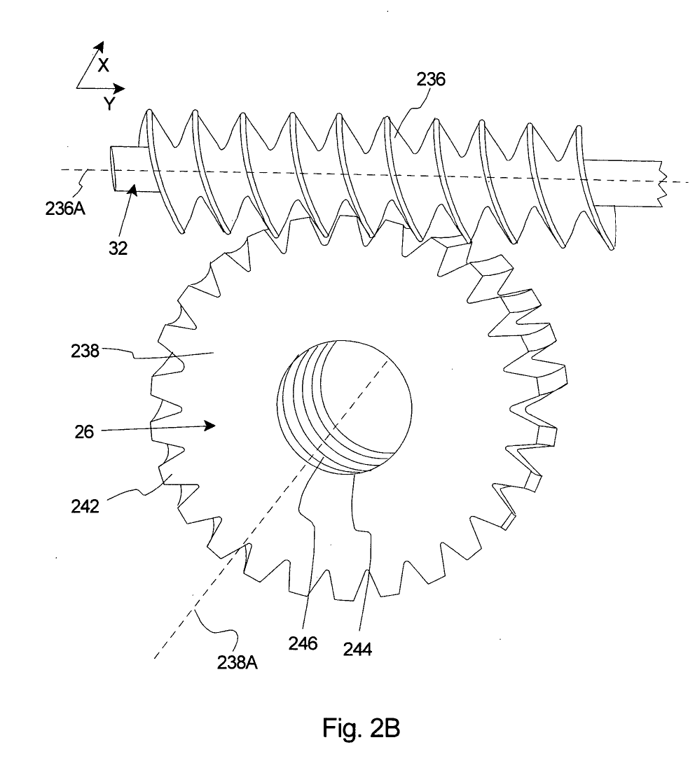

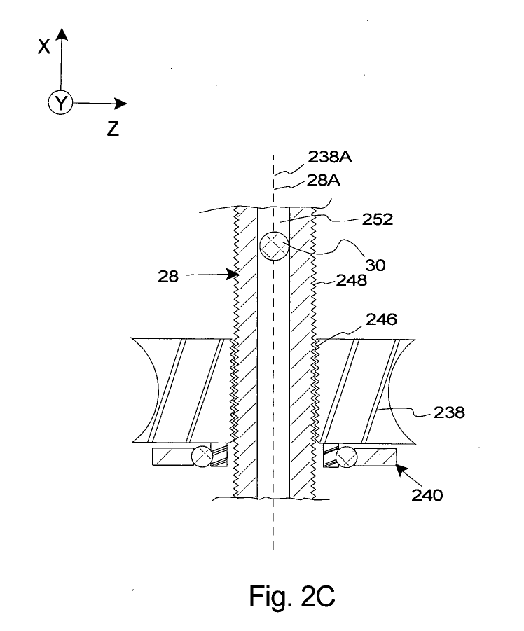

FIG. 2A is a simplified plan view a portion of the mover assembly 16 of FIG. 1, namely, the mover output 32, the gear assembly 26, the assembly output 28, and the rotation inhibitor 30.

The mover output 32 engages the gear assembly 26. FIG. 2B is a perspective view of the mover output 32 and a portion of the gear assembly 26. In this embodiment, referring to FIGS. 2A and 2B, the mover output 32 is a generally cylindrical shaped shaft and includes a worm 236, e.g. an externally threaded region. In one embodiment, the worm 236 has a relatively fine thread pitch. Further, in one embodiment, each thread has a generally triangular shaped cross-sectional shape. As examples, in alternative nonexclusive embodiments, the worm 236 has a pitch of at least approximately 20, 30, 40, 50, 60, 70, or 80 threads per inch. It should be noted that the pitch of the externally threaded region can be greater than or less than the above identified pitches. In this embodiment, the worm 236 is rotated about a worm axis 236A, e.g. about the Y axis. In one embodiment, the worm 236A is integrally formed into a portion of the mover output 32.

The gear assembly 26 includes a ring gear 238 and a gear bearing assembly 240. In one embodiment, the ring gear 238 is somewhat disk shaped and includes a gear externally threaded surface 242 that corresponds to, mates with, matches and engages the worm 236. In one embodiment, the gear externally threaded surface 242 has a relatively fine thread pitch. For example, in alternative nonexclusive embodiments, the gear externally threaded surface 242 has a thread pitch of at least approximately 20, 30, 40, 50, 60, 70, or 80 threads per inch. It should be noted that the pitch of the gear externally threaded surface 242 can be greater than or less than the above identified thread pitches.

The gear 238 engages the worm 236 so that rotation of the worm 236 about the worm axis 236A results in rotation of the gear 238 about a gear axis 238A, e.g. the X axis. In one embodiment, the ring gear 238 tangentially mates threads with the worm 236. In this embodiment, the gear axis 238A is not parallel with the worm axis 236A. More specifically, in this embodiment, the gear axis 238A is transverse to the worm axis 236A.

In one embodiment, the gear diameter of the gear 238 is larger than the worm diameter of the worm 236. In one embodiment, the gear diameter is approximately one quarter of an inch. It should be noted that the gear diameter can be greater than or less than this amount or the gear diameter can be less than the worm diameter.

In one embodiment, the gear 238 interacts with the worm 236 to transform relatively large rotations of the mover output 32 into relatively small rotations of the gear 238 and ultimately relatively small movements of the assembly output 28. With this design, a full rotation of the worm 236 results in only a partial rotation of the gear 238. The amount of reduction will be a function of the thread pitch of the worm 236 and the gear diameter.

Additionally, the gear 238 can include a gear aperture 244 that is sized and shaped to receive the assembly output 28. In one embodiment, the gear aperture 244 is coaxial with the gear axis 238A. Additionally, in this embodiment, the gear aperture 244 includes a gear internally threaded surface 246. For example, in alternative nonexclusive embodiments, the gear internally threaded surface 246 has a thread pitch of at least approximately 20, 30, 40, 50, 60, 70, or 80 threads per inch. It should be noted that the pitch of the gear internally threaded surface 246 can be greater than or less than the above identified thread pitches.

FIG. 2C is a cut-away view taken on line 2C-2C in FIG. 2A. Referring to FIGS. 2A and 2C, the gear bearing assembly 240 allows for rotation of the gear 238 about the gear axis 238A and inhibits movement of the gear 238 along the gear axis 238A. In one embodiment, the gear bearing assembly 240 is a roller type bearing that includes an inner race that is secured to the gear 238, an outer race that is secured to the assembly frame 24 (illustrated in FIG. 1) and a plurality of spherical balls that connect the races. Alternatively, for example, the gearing bearing assembly can include multiple bearings and/or the bearing can include a bushing or another type of bearing.

The assembly output 28 is coupled to the gear 238 so that rotation of the gear results 238 in movement of the assembly output 28 along an output axis 28A, e.g. the X axis. In one embodiment the output axis 28A is coaxial with the gear axis 238A.

In one embodiment, the assembly output 28 is cylindrical shaft shaped and includes an output externally threaded surface 248 that corresponds to, mates with and engages the gear internally threaded surface 246. For example, in alternative nonexclusive embodiments, the output externally threaded surface 248 has a thread pitch of at least approximately 20, 30, 40, 50, 60, 70, or 80 threads per inch. It should be noted that the pitch of the output externally threaded surface 248 can be greater than or less than the above identified thread pitches.

In one embodiment, a distal end of the assembly output 28 can include a ball 250 that fits into an aperture at the distal shaft end. With this design, the assembly output 28 has a rounded tip. The ball 250 engages the object 12 (illustrated in FIG. 1) to transfer the linear movement of the assembly output 28 to the object 12. In another embodiment, the distal end can be substantially flat or have another shape as needed. In one embodiment, the assembly output 28 is made of stainless steel or other hard material.

Additionally, the assembly output 28 can include a longitudinally extending slot 252 for receiving a portion of the rotation inhibitor 30. In one embodiment, the slot 252 is generally rectangular shaped and extends along at least a portion of the assembly output 28.

The rotation inhibitor 30 inhibits rotation of the assembly output 28 about the output axis 28A concurrently with the gear 238 and allows for movement of the assembly output 28 along the output axis 28A transversely to the gear 238. In one embodiment, the rotation inhibitor 30 is a beam having a first end that is fixedly secured to the assembly frame 24 (illustrated in FIG. 1) and a second end that extends into the slot 252.

Alternatively, for example, the rotation inhibitor 30 can include a linear bearing that couples the assembly frame 24 to the assembly output 28 and allows for movement of the assembly output 28 linearly.

With the design provided herein, rotation of the worm 236A about the worm axis 236A results in rotation of the gear 238 about the gear axis 238A and movement of the assembly output 28 linearly along the output axis 28A.

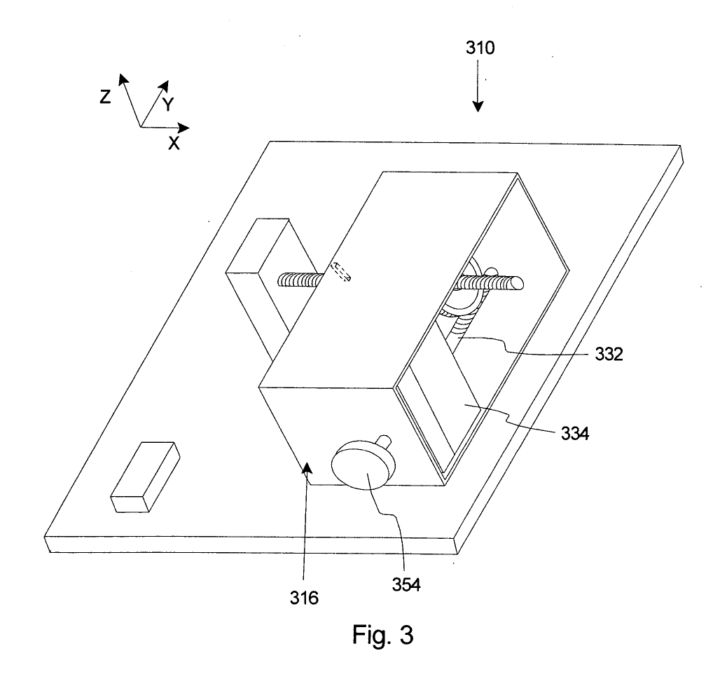

FIG. 3 is a perspective view of a portion of another embodiment of an apparatus 310 including a mover assembly 316. In this embodiment, mover assembly 316 is somewhat similar to the mover assembly 16 described above. However, in this embodiment, the mover assembly 316 includes a handle 354 that can be used to manually rotate the mover output 332 in addition to the motor 334. Alternatively, the mover assembly 316 can be designed without the motor 334.

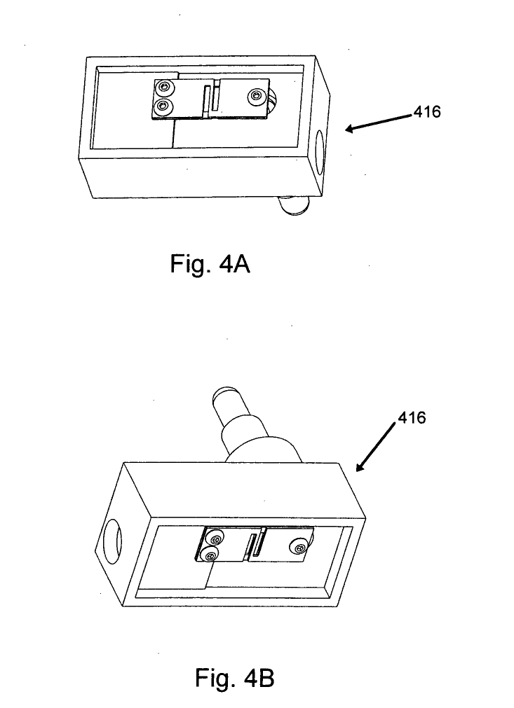

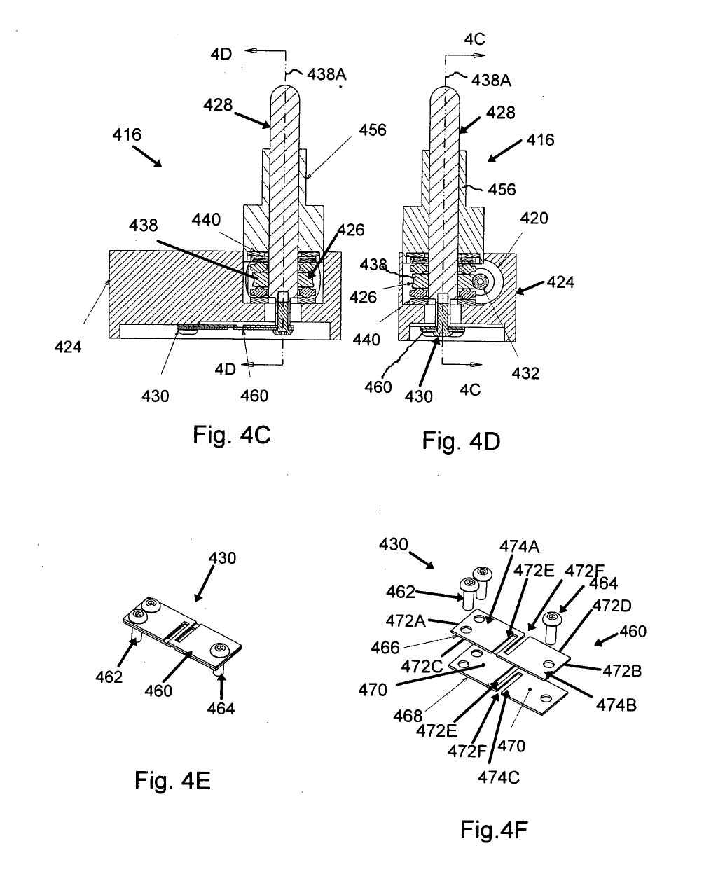

FIGS. 4A and 4B illustrate another embodiment of a mover assembly 416 that can be used in the apparatus 10 of FIG. 1. FIGS. 4C and 4D are alternative cross-sectional views of the mover assembly 416. In this embodiment, the mover assembly 416 includes a mover 420, an assembly frame 424, a gear assembly 426, and an assembly output 428 that are somewhat similar to the corresponding components described above. More specifically, in this embodiment, the mover 420 moves the mover output 432. The mover output 432 engages the gear 438 and causes rotation of the gear 438 about the gear axis 438A. The gear 438 engages the assembly output 428 while the rotation inhibitor 430 inhibits rotation of the assembly output 428. With this design, the assembly output 428 moves laterally along the gear axis 238A.

However, in this embodiment, the gear bearing assembly 440 and the rotation inhibitor 430 are slightly different. More specifically, in this embodiment, the gear bearing assembly 440 allows for rotation of the gear 438, inhibits movement of the gear 438 along the gear axis 438A and allows for radial movement of the gear 438. In this embodiment, the gear bearing assembly 440 includes a pair of opposed thrust bearings that are positioned on opposite sides of the gear 438.

Additionally, in this embodiment, the mover assembly 416 includes an output guide 456 that guides movement of the assembly output 428 along the gear axis 438A and inhibits radial movement of the assembly output 428 and the gear 438. In this embodiment, the output guide 456 is secured to the assembly frame 424, and the output guide 456 is a bushing that guides the movement of the assembly output 428. Further, in this embodiment, only the portion of the assembly output 428 near the gear 438 includes the output externally threaded surface (not shown).

Moreover, in this embodiment, the rotation inhibitor 430 includes a resilient assembly 460 that connects the assembly output 428 to the assembly frame 424, inhibits rotation of the assembly output 428 about the gear axis 438A, and allows for movement of the assembly output 428 along the gear axis 438A.

FIG. 4E illustrates a perspective view of the rotation inhibitor 430 and FIG. 4F illustrates an exploded perspective view of the rotation inhibitor 430. In this embodiment, the rotation inhibitor 430 includes (i) the resilient assembly 460 having opposed ends, (ii) a pair of frame fasteners 462, e.g. a pair of bolts, that secure one end of the resilient assembly 460 to the assembly frame 424 (illustrated in FIGS. 4C-4D) and (iii) an output fastener 464, e.g. a bolt, that secures the other end of the resilient assembly 460 to the assembly output 428 (illustrated in FIGS. 4C-4D).

In this embodiment, the resilient assembly 460 includes a first beam 466, a second beam 468, and a beam attacher 470 that secures the beams 466, 468 together. In this embodiment, the each beam 466, 468 is generally rectangular shaped and includes (i) a first end 472A, (i) a second end 472B that is opposite the first end 472A, (iii) a front edge 472C, and (iv) a rear edge 472D that is opposite the front edge 472C, (v) a rectangular shaped first slot 472E, and (vii) a rectangular shaped second slot 472F. Additionally, in this embodiment, (i) for the first beam 466, the first slot 472E extends from the front edge 472C partly towards rear edge 472D and the second slot 472F extends from the rear edge 472D partly towards front edge 472E, and (ii) for the second beam 468, the first slot 472E extends from the rear edge 472D partly towards front edge 472C and the second slot 472F extends from the front edge 472E partly towards rear edge 472D. The resulting structure of each beam 466, 468 includes a generally rectangular shaped left region 474A, a generally rectangular shaped right region 474B, and a somewhat “S” shaped connector region 474C that connects the left and right regions 474A, 474B together.

In one embodiment, the beam attacher 470 fixedly secures the left region 474A of each beam 466, 468 together and/or the right region 474B of each beam 466, 468 together. In one embodiment, the beam attacher 470 can be an adhesive, solder or a weld.

When the beams 466, 468 are secured together, (i) a portion of the first slot 472E of the first beam 466 is positioned over a portion of the first slot 472E of the second beam 468, and (ii) a portion of the second slot 472F of the first beam 466 is positioned over a portion of the second slot 472F of the second beam 468.

While the particular mover assembly 16 as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

1. A mover assembly that adjusts a position or shape of an object, the mover assembly comprising:
a mover output that is moved;
a gear including gear teeth that engage the mover output so that movement of the mover output results in rotation of the gear; and
an assembly output that is coupled to the gear so that rotation of the gear results in movement of the assembly output along an axis, the assembly output being coupled to the object.

2. The mover assembly of claim 1 further comprising a rotation inhibitor that inhibits rotation of the assembly output and allows for movement of the assembly output along the axis.

3. The mover assembly of claim 1 wherein the mover output includes a worm that engages the gear so that movement of the worm about a worm axis results in rotation of the gear about the axis, the axis being different than the worm axis.

4. The mover assembly of claim 3 wherein the worm has a thread pitch of between approximately 20 and 80 threads per inch.

5. The mover assembly of claim 1 wherein the gear includes a gear aperture and the assembly output is positioned within the gear aperture.

6. The mover assembly of claim 5 wherein the gear includes a gear internally threaded surface and the assembly output includes an output externally threaded surface that engages the gear internally threaded surface.

7. The mover assembly of claim 1 further comprising a gear bearing assembly that allows for rotation of the gear.

8. The mover assembly of claim 1 further comprising a motor that rotates the mover output.

9. The mover assembly of claim 1 further comprising a measurement system that monitors the movement of the mover output.

10. A precision apparatus including an object and the mover assembly of claim 1.

11. A mover assembly that adjusts a position or shape of an object, the mover assembly comprising:
a worm that is rotated about a worm axis;
a gear that engages the worm so that rotation of the worm results in rotation of the gear about a gear axis that is substantially transverse to the worm axis; and
an assembly output that is coupled to the gear, wherein rotation of the gear results in movement of the assembly output along an output axis that is coaxial with the gear axis, the assembly output being coupled to the object.

12. The mover assembly of claim 11 further comprising a rotation inhibitor that inhibits rotation of the assembly output and allows for movement of the assembly output along the output axis.

13. The mover assembly of claim 11 wherein the worm has a thread pitch of between approximately 20-80 threads per inch.

14. The mover assembly of claim 11 wherein the gear includes a gear aperture and the assembly output is positioned within the gear aperture.

15. The mover assembly of claim 14 wherein the gear includes a gear internally threaded surface and the assembly output includes an output externally threaded surface that engages the gear internally threaded surface.

16. The mover assembly of claim 11 further comprising a gear bearing assembly that allows for rotation of the gear.

17. The mover assembly of claim 11 further comprising a motor that rotates the mover output.

18. A precision apparatus including an object and the mover assembly of claim 11.

19. A mover assembly that adjusts a position or shape of an object, the mover assembly comprising:
a worm;
a motor that rotates the worm about a worm axis;
a gear that engages the worm so that rotation of the worm results in rotation of the gear about a gear axis that is transverse to the worm axis, the gear including a gear internally threaded surface that is coaxial with the gear axis;
a gear bearing assembly that allows for rotation of the gear about the gear axis and inhibits movement of the gear along the gear axis;
an assembly output having an output externally threaded surface that engages the gear internally threaded surface; and
a rotation inhibitor that inhibits rotation of the assembly output about the gear axis.

20. The mover assembly of claim 19 wherein the worm has a thread pitch of between approximately 20 and 80 threads per inch.

21. The mover assembly of claim 19 further comprising a measurement system that monitors the movement of the mover output.

22. A precision apparatus including an object and the mover assembly of claim 19.

23. A method for moving or positioning an object, the method comprising the steps of:
moving a mover output;
engaging the mover output with gear teeth of a gear so that movement of the mover output results in rotation of the gear; and
coupling an assembly output to the gear so that rotation of the gear results in movement of the assembly output along an axis, the assembly output being coupled to the object.

24. The method of claim 23 further comprising the step of inhibiting rotation of the assembly output with a rotation inhibitor that allows for movement of the assembly output along the axis.

25. The method of claim 23 further comprising the step of positioning the assembly output within a gear aperture of the gear.

26. A method for moving or positioning an object, the method comprising the steps of:
providing a worm;
rotating the worm about a worm axis with a motor;
engaging the worm with a gear so that rotation of the worm results in rotation of the gear about a gear axis that is transverse to the worm axis, the gear including a gear internally threaded surface that is coaxial with the gear axis;
supporting the gear with a gear bearing assembly that allows for rotation of the gear about the gear axis and inhibits movement of the gear along the gear axis;
providing an assembly output having an output externally threaded surface that engages the gear internally threaded surface; and
inhibiting rotation of the assembly output about the gear axis with a rotation inhibitor.

27. A rotation inhibitor that inhibits movement of an assembly output along an axis relative to an assembly frame and allows for movement of the assembly output along the axis relative to the assembly frame, the rotation inhibitor comprising a resilient assembly having a first end that is fixedly secured to the assembly frame and a second end that is fixedly secured to the assembly output, the resilient assembly including a first beam, a second beam, and a beam attacher that fixedly secures a portion of the first beam to a portion of the second beam.

28. The rotation inhibitor of claim 27 wherein each beam includes a first slot and wherein a portion of the first slot of the first beam is positioned over a portion of the first slot of the second beam.

29. The rotation inhibitor of claim 28 wherein each beam includes a second slot and wherein a portion of the second slot of the first beam is positioned over a portion of the second slot of the second beam.

30. A mover assembly that adjusts a position or shape of an object, the mover assembly comprising:
an assembly frame;
a worm that is moved relative to the assembly frame;
a gear that engages the worm so that movement of the worm results in rotation of the gear about the axis;
an assembly output that is coupled to the gear, wherein rotation of the gear results in movement of the assembly output along the axis, the assembly output being coupled to the object; and
the rotation inhibitor of claim 27 that couples the assembly output to the assembly frame, the rotation inhibitor allowing for movement of the assembly output along the axis and inhibiting rotation of the assembly output about the axis.
